(19) United States
(12) Patent Application Publication
(10) Pub. No.: US 2015/0339026 A1
(43) Pub. Date: Nov. 26, 2015

(54) USER TERMINAL DEVICE, METHOD FOR CONTROLLING USER TERMINAL DEVICE, AND MULTIMEDIA SYSTEM THEREOF

(71) Applicant: SAMSUNG ELECTRONICS CO., LTD., Suwon-si (KR)

(72) Inventors: Joon-ho PHANG, Seoul (KR); Chang-seog KO, Hwaseong-si (KR); Jae-ki KYOUN, Seoul (KR); Jae-yeop KIM, Seoul (KR); Ha-yeon YOO, Seongnam-si (KR); Seong-wook JEONG, Seoul (KR); Christophe NAOURJEAN, Anyang-si (KR); Kwan-min LEE, Seoul (KR)

(73) Assignee: SAMSUNG ELECTRONICS CO., LTD., Suwon-si (KR)

(21) Appl. No.: 14/702,178

(22) Filed: May 1, 2015

(30) Foreign Application Priority Data
May 22, 2014 (KR) 10-2014-0061743

(51) Int. Cl. G06F 3/0488; H04N 21/41; H04N 21/422; H04N 5/60; H04N 21/438; H04N 5/38; H04N 5/50; H04N 5/44; H04N 21/426

(52) U.S. Cl. CPC G06F 3/0488; H04N 5/44; H04N 21/4126; H04N 21/422; H04N 21/4263; H04N 21/4383; H04N 5/38; H04N 5/50; H04N 5/60; G06F 2203/04808; H04N 2005/443; H04N 2005/4408

(57) ABSTRACT

A user terminal device, a controlling method thereof, and a multimedia system are provided. The method of controlling a user terminal device including a display includes displaying a first image content on the display, detecting a touch gesture with respect to the user terminal device, controlling the user terminal device in response to the touch gesture being a single-touch gesture, and transmitting data for controlling a first external apparatus to the first external apparatus in response to the touch gesture being a multi-touch gesture.

### CROSS-REFERENCE TO RELATED APPLICATIONS

This application claims priority from Korean Patent Application No. 10-2014-0061743, filed in the Korean Intellectual Property Office on May 22, 2014, the disclosure of which is incorporated herein by reference.

### BACKGROUND

1. Field

Apparatuses, methods and systems consistent with exemplary embodiments relate to a user terminal device, a method for controlling the user terminal device, and a multimedia system thereof, and more particularly, to a user terminal device that enables a user to view an image content that is displayed on a display apparatus and simultaneously displayed on the user terminal device, a method for controlling the user terminal device, and a multimedia system thereof.

2. Description of the Related Art

A recent display apparatus provides a user with the ability to select various content, and the user may view multiple image contents (e.g., more than one broadcast channel) at the same time and then select a desired content from among those various image contents.

In the related art, displays may include a Picture in Picture (PIP) function that allows a user to simultaneously display a plurality of different image contents. However, the PIP function may interfere with the viewing of content as one image content may cover or overlay another image content. In addition, it is difficult to control an original image content and a PIP image content simultaneously through a single remote controller.

Alternatively, a plurality of display apparatuses may be used to display a plurality of image contents at the same time. For example, a television (TV) and a smart phone may be used to separately display image content. However, in this case, the plurality of display apparatuses are not interlocked with one another and thus, each of the plurality of display apparatuses must be controlled individually.

### SUMMARY

One or more exemplary embodiments provide a user terminal device which allows a user to display a content that is currently being reproduced by a display apparatus, a method for controlling the user terminal device, and a multimedia system thereof.

According to an aspect of an exemplary embodiment, there is provided a method of controlling a user terminal device including a display, the method including displaying a first image content on the display, detecting a touch gesture with respect to the user terminal device, in response to the detected touch gesture being determined to be a single-touch gesture, controlling the user terminal device, and in response to the detected touch gesture being determined to be a multi-touch gesture, transmitting data to a first external apparatus for controlling the first external apparatus.

The transmitting may include, in response to the multi-touch gesture being a drag gesture using at least two fingers in an upward or downward direction, transmitting data for controlling a volume level of the first external apparatus.

The transmitting may include, in response to the multi-touch gesture being a swipe gesture using at least two fingers in a left or right direction, transmitting data for changing a channel of the first external apparatus.

The transmitting may include, in response to the multi-touch gesture being a swipe gesture using at least three fingers, transmitting data for turning off the first external apparatus.

The transmitting may include, in response to the multi-touch gesture being a rotation gesture using at least two fingers, transmitting data for removing a graphic object displayed on the first external apparatus.

The first image content may be received from the first external apparatus, the displaying the first image content may be synchronized with display of the first image content on the first external apparatus.

The first image content may be transmitted from a server, the displaying the first image content may be synchronized with display of the first image content on the first external apparatus.

The transmitting may include transmitting data so that a function performed on the user terminal device according to the single-touch gesture is performed on the first external apparatus according to the multi-touch gesture in a same manner.

The transmitting may include transmitting data for changing an amount of change of a volume level or a channel of the first external apparatus based on the number of multi-touch of the multi-touch gesture.

The transmitting may include, in response to the multi-touch gesture being a gesture using two fingers, transmitting data for controlling the first external apparatus, and in response to the multi-touch gesture being a gesture using three fingers, transmitting data for controlling a second external apparatus.

According to an aspect of another exemplary embodiment, there is provided a user terminal device that operates in association with a first external apparatus, the user terminal device including a display configured to display a first image content, a communicator configured to perform communication with the first external apparatus, a detector configured to detect a touch gesture with respect to the user terminal device, and a controller configured to control the user terminal device in response to the touch gesture detected by the detector being a single-touch, and control the communicator to transmit data for controlling the first external apparatus in response to the touch gesture detected by the detector being a multi-touch gesture.

The controller may be configured to, in response to the multi-touch gesture being a drag gesture using at least two fingers in an upward or downward direction, control the communicator to transmit data for controlling a volume level of the first external apparatus.

The controller may be configured to, in response to the multi-touch gesture being a swipe gesture using two fingers in a left or right direction, control the communicator to transmit data for changing a channel of the first external apparatus.

The controller may be configured to, in response to the multi-touch gesture being a swipe gesture using three fingers, control the communicator to transmit data for turning off the first external apparatus.

The controller may be configured to, in response to the multi-touch gesture being a rotation gesture using two fingers, control the communicator to transmit data for removing a graphic object displayed on the first external apparatus.

The first image content may be received from the first external apparatus, the display of the first image content by the display may be synchronized with display of the first image content on the first external apparatus.

The first image content may be transmitted from a server, the display of the first image content by the display may be synchronized with display of the first image content on the first external apparatus.

The controller may be configured to control the communicator to transmit data so that a function performed on the user terminal device according to the single-touch gesture is also performed on the first external apparatus according to the multi-touch gesture in a same manner.

The controller may be configured to, in response to the multi-touch gesture being determined to be a swipe gesture using two fingers in a left or right direction, control the communicator to transmit data for changing a channel of the first external apparatus in a consecutive manner, and in response to the multi-touch gesture being determined to be a swipe gesture using three fingers in a left-and-right direction, control the communicator to transmit data for changing a channel of the first external apparatus in a non-consecutive manner.

The controller may be configured to, in response to the multi-touch gesture being determined to be a gesture using two fingers, control the communicator to transmit data for controlling the first external apparatus, and in response to the multi-touch gesture being determined to be a gesture using three fingers, control the communicator to transmit data for controlling a second external apparatus.

### BRIEF DESCRIPTION OF THE DRAWINGS

The above and/or other aspects will be more apparent by describing certain exemplary embodiments with reference to the accompanying drawings, in which:

FIG. 1 is a view illustrating a multimedia system according to an exemplary embodiment;

FIG. 2 is a block diagram illustrating a configuration of a user terminal device according to an exemplary embodiment;

FIG. 3 is a block diagram illustrating configuration of a user terminal device in detail according to an exemplary embodiment;

FIGS. 4A and 4B are views illustrating a screen that is displayed on a user terminal device and a display of a first external apparatus when a detector of the user terminal device detects a single-touch gesture according to an exemplary embodiment;

FIGS. 5A and 5B are views illustrating a screen that is displayed on a user terminal device and a display of a first external apparatus when a detector of the user terminal device detects a multi-touch gesture according to an exemplary embodiment;

FIGS. 5C and 5D are views illustrating that a channel of a first external apparatus is changed by a left or right gesture of two fingers while a first image content is displayed on a user terminal device according to an exemplary embodiment;

FIGS. 6A and 6B are views illustrating a first external apparatus according to an exemplary embodiment that is controlled differently according to whether detected gesture is determined to a gesture using two fingers or three fingers, which is detected on a user terminal device;

FIGS. 7A and 7B are views illustrating a first layer displayed on a display of a first external apparatus is removed based on a multi-touch gesture detected on a user terminal device according to another exemplary embodiment;

FIGS. 8A and 8B are views illustrating a virtual remote controller for controlling a first external apparatus that is displayed on a user terminal device in response to a multi-touch gesture being detected on the user terminal device according to another exemplary embodiment;

FIGS. 9A and 9B are views illustrating that a first external apparatus is turned off according to a multi-touch gesture detected on a user terminal device according to another exemplary embodiment;

FIGS. 10A and 10B are views illustrating that a first external apparatus or a second external apparatus is controlled according to a multi-touch gesture of two fingers or three fingers detected on a user terminal device;

FIG. 11 is a view illustrating a vibration feedback according to an exemplary embodiment which is generated as a multi-touch gesture is detected on a user terminal device;

FIG. 12 is a block diagram illustrating an internal configuration of a first external apparatus according to an exemplary embodiment; and

FIG. 13 is a flowchart illustrating a method of controlling a user terminal device 100 according to an exemplary embodiment.

### DETAILED DESCRIPTION

The exemplary embodiments may vary, and different aspects may be provided in different exemplary embodiments. Specific exemplary embodiments will be described with reference to accompanying drawings and detailed explanation. However, this does not necessarily limit the scope of the exemplary embodiments to a specific embodiment form. Instead, modifications, equivalents and replacements included in the disclosed concept and technical scope of this specification may be employed.

In the present disclosure, relational terms such as first and second, and the like, may be used to distinguish one entity from another entity or one operation from another operation, without necessarily implying any actual relationship or order between such entities or operations.

The terms used in the following description are provided to explain a specific exemplary embodiment and are not intended to limit the scope of any rights. A singular term is understood as also including a plural form unless it is intentionally specified otherwise. The terms, “include”, “comprise”, “is configured to”, etc. of the description are used to indicate that there are features, numbers, steps, operations, elements, parts or combination thereof, and they should not exclude the possibilities of combination or addition of one or more features, numbers, steps, operations, elements, parts or combination thereof.

In an exemplary embodiment, ‘a module’ or ‘a unit’ performs at least one function or operation, and may be realized as hardware, software, or combination thereof. In addition, a plurality of ‘modules’ or a plurality of ‘units’ may be integrated into at least one module and may be realized as at least one processor (not shown) except for ‘modules’ or ‘units’ that should be realized in a specific hardware.

In addition, “and/or” in this specification refers to and include all and every possible combination of one or more items from among related items which are enumerated.

Further, “in case ˜ (if ˜)” in this specification may be interpreted as “when ˜”, “at the same time when ˜”, “in response to determining ˜”, or “in response to detecting ˜.” Similarly, they should be interpreted as “in case of determining ˜” or “if detecting (the aforementioned condition or event)”, or “in response to detecting (the aforementioned condition or event).”

A ‘touch’ is not limited to an actual physical contact between a display of a user terminal device and a user's body or a touchable input apparatus (for example, a touch pen), and a ‘touch’ may also include a non-contact interaction (for example, hovering of a user's body or an input apparatus over a display with a distance of less than 30 mm). The distance of a detectable non-contact may vary depending on performance or structure of a user terminal device.

In addition, touch, drag, swipe and flick of a display shall be interpreted as touching, dragging, swiping, and flicking of an object displayed on the display.

Hereinafter, an exemplary embodiment will be described in detail with accompanying drawings.

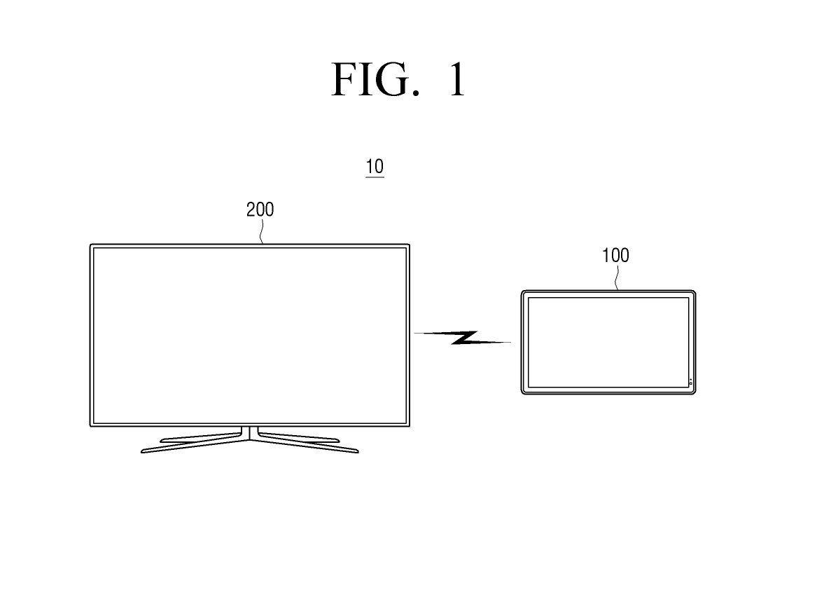

FIG. 1 is a view illustrating a multimedia system 10 according to an exemplary embodiment. As illustrated in FIG. 1, the multimedia system 10 includes a user terminal device 100 and an external apparatus 200. The external apparatus 200 may be a display apparatus, such as a TV display or monitor. In this case, the user terminal device 100 may be a separate remote controlling device including a display to control the external apparatus 200, but this is only an example. The user terminal device 100 may be realized as various portable user terminal devices such as a smart phone, a tablet personal computer (PC), etc. In addition, the external apparatus 200 may be a smart TV, but this is only an example. The external apparatus 200 may also be realized as various devices such as a digital TV, a desktop PC, a notebook PC, an audio apparatus, a lighting apparatus, etc.

The user terminal device 100 and the external apparatus 200 may be connected to each other using various communication methods. For example, the user terminal device 100 and the external apparatus 200 may perform communication with each other using a wireless communication module such as Bluetooth, Wi-Fi, etc.

The user terminal device 100 and the external apparatus 200 may display a first image content. Here, displaying an image content may be reproducing an image content. The first image content displayed by the user terminal device 100 may be received from the external apparatus 200, but this is only an example. The first image content may be received from a separate external apparatus or may be a pre-stored image content. In addition, the first image content may be a broadcast content such as a satellite or cable broadcast program, but this is only an example. The first image content may be a video on demand (VOD) image content received via Internet or a pre-stored image content.

If a user's touch gesture is detected while the user terminal device 100 displays the first image content, the user terminal device 100 may determine whether the touch gesture is a single-touch gesture or a multi-touch gesture. The user's touch gesture may be the motion of moving fingers while the user contacts or approaches a display and maintains the contacting or approaching motion.

The user terminal device 100 may transmit data for controlling the user terminal device if the touch gesture is a single-touch gesture and controlling the external apparatus if the touch gesture is a multi-touch gesture, to the external apparatus 200. In this case, the external apparatus 200 may be a display apparatus. Control of the user terminal device is not limited to a single touch gesture, however. In another exemplary embodiment, the user terminal device 100 may transmit data for controlling the user terminal device if the touch gesture is a multi-touch gesture and the external apparatus may be controlled if the touch gesture is determined to be a single, touch gesture.

The multi-touch gesture may include at least one of a touch, swipe, drag, and rotation gesture using at least two fingers of a user.

If a multi-touch gesture is a drag gesture using two fingers, the user terminal device 100 may transmit data to control the volume level of the external apparatus 200.

If a multi-touch gesture is a swipe gesture using two fingers in a left or right direction, the user terminal device 100 may transmit data to change a channel of the external apparatus 200.

If a multi-touch gesture is a swipe gesture using three fingers, the user terminal device 100 may transmit data to turn off the external apparatus 200.

If a multi-touch gesture is a rotation gesture using two fingers, the user terminal device 100 may transmit data to remove a graphic object displayed on the external apparatus 200.

The first image content may be received from the external apparatus 200, and reproduction of the first image content item may be synchronized with a content reproduced by the external apparatus 200.

The first image content may be transmitted from a server, and reproduction of the first image content may be synchronized with a content reproduced by the external apparatus 200.

In addition, the user terminal device 100 may transmit data such that a function performed by the user terminal device 100 according to a single-touch gesture is performed on the external apparatus 200 in the same manner according to a multi-touch gesture.

If a multi-touch gesture is a drag gesture using two fingers, the user terminal device 100 may transmit data to change a volume level of the external apparatus 200 in a sequential manner, and if a multi-touch gesture is a drag gesture using three fingers, the user terminal device 100 may transmit data to change a volume level of the external apparatus 200 in a non-sequential manner.

If a multi-touch gesture is a gesture using two fingers, the user terminal device 100 may transmit data to control the external apparatus 200, and if a multi-touch gesture is a gesture using three fingers, the user terminal device 100 may transmit data to control another external apparatus.

As described above, according to the multimedia system 10, a user may control the external apparatus 200 more intuitively using the user terminal device 100.

In the above exemplary embodiment, a multi-touch gesture using two fingers or three fingers have been described with respect to the user terminal device 100, but this is only an example. It is possible to use a multi-touch gesture using more than three fingers.

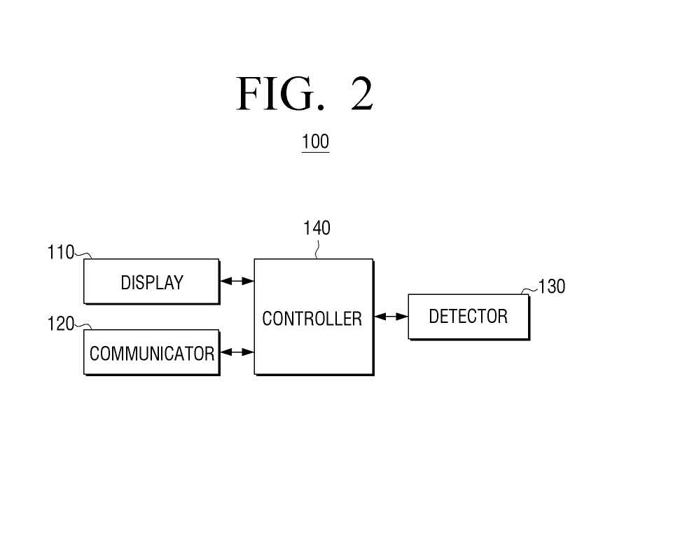

FIG. 2 is a block diagram illustrating configuration of the user terminal device 100 briefly according to an exemplary embodiment. As illustrated in FIG. 2, the user terminal device 100 includes a display 110, a communicator 120, a detector 130, and a controller 140.

The display 110 displays various image contents under the control of the controller 140. In particular, the display 110 may display an image content received from the external apparatus 200. In this case, if an image stream containing a first image content is received from the external apparatus 200, the display 110 may display the first image content.

The display 110 may be realized as a touch screen in combination with a touch detector of the detector 130. Hereinafter, a user terminal device where the detector is combined with the display 110 will be described as an example. In addition, it is assumed that the display 110 includes the detector 130 as long as there is description otherwise. In other words, the display 110 may be a touch screen. However, this is only an example, and in an alternative embodiment the user terminal device may be configured such that the display 110 and the detector 130 are provided separately.

The communicator 120 performs communication with various external apparatuses. In particular, the communicator 120 may perform communication with the first external apparatus 200. In this case, the communicator 120 may receive an image content from the first external apparatus 200 in real time, and transmit a content request signal for requesting an image content to the first external apparatus 200.

The detector 130 detects a touch gesture to control the user terminal device 100. In particular, the detector 130 may be realized as a touch detector in a touch screen, which can detect a user's touch gesture (for example, a drag gesture).

The controller 140 controls overall operations of the user terminal device 100. The user terminal device 100 may control the communicator 120 to transmit a signal for requesting an image content to the first external apparatus 200. If an image content that is currently displayed by the first external apparatus 200 is received by the user terminal device 100 from the first external apparatus 200, the controller 140 may control the display 110 to display the image content. In this case, the first external apparatus 200 may be a display apparatus. In the following exemplary embodiment, the first external apparatus 200 will be described as a display apparatus.

If a touch gesture is detected by the detector 130 while the display 110 displays the first image content, the controller 140 may determine whether the detected touch gesture is a single-touch gesture or a multi-touch gesture. The single-touch gesture may be a motion of touching the display 110 using one finger and moving the finger while maintaining the touch.

The multi-touch gesture may be a motion of touching two different points of the display 110 using two fingers and moving the two fingers simultaneously or just one finger while maintaining the touch.

If a touch gesture detected by the detector 130 is a single-touch gesture, the controller 140 may control the first image content displayed on the display 110 of the user terminal device 100 based on the single-touch gesture. For example, if a user swipes the display 110 from left to right or right to left using one finger, the controller 140 may change the first image content that is currently displayed to a second image content of another channel.

If a user drags the display 110 from top to bottom or bottom to top using one finger, the controller 140 may increase or decrease a volume level of the user terminal device 100. Herein, the drag motion may be replaced with a scroll motion or a swipe motion. In other words, if a user scrolls the display 110 from top to bottom or bottom to top using one finger, the controller 140 may increase or decrease a volume level of the user terminal device 100. If a user swipes the display 110 from top to bottom or bottom to top using one finger, the controller 140 may increase or decrease a volume level of the user terminal device 100.

If a touch gesture detected through the detector 130 is a multi-touch gesture, the controller 140 may control the communicator 120 to transmit data for controlling the first external apparatus 200 based on the multi-touch gesture, to the first external apparatus 200. If a multi-touch gesture is detected, the controller 140 may search whether there is command data corresponding to the multi-touch gesture. The controller 140 may control the communicator 120 to transmit command data corresponding to the detected multi-touch gesture to the first external apparatus 200.

The command data may be data to control the first external apparatus 200. The first external apparatus 200 may be a display apparatus. The first external apparatus 200 may receive command data from the user terminal device 100 and perform a corresponding operation.

The multi-touch gesture may include at least one of a touch, swipe, drag, and rotation gesture using a user's two fingers or more. If the multi-touch gesture is a drag gesture using two fingers in an upward or downward direction, the controller 140 may control the communicator 120 to transmit data to control a volume level of the first external apparatus 200. The first external apparatus 200 may be a display apparatus.

If the multi-touch gesture is a swipe gesture using two fingers in a left or right direction, the controller 140 may control the communicator 120 to transmit data to change a channel of the first external apparatus 200. If the multi-touch gesture is a swipe gesture using three fingers, the controller 140 may control the communicator 120 to transmit data to turn off the first external apparatus 200. If the multi-touch gesture is a rotation gesture using two fingers, the controller 140 may control the communicator 120 to transmit data to remove a graphic object displayed on the first external apparatus 200.

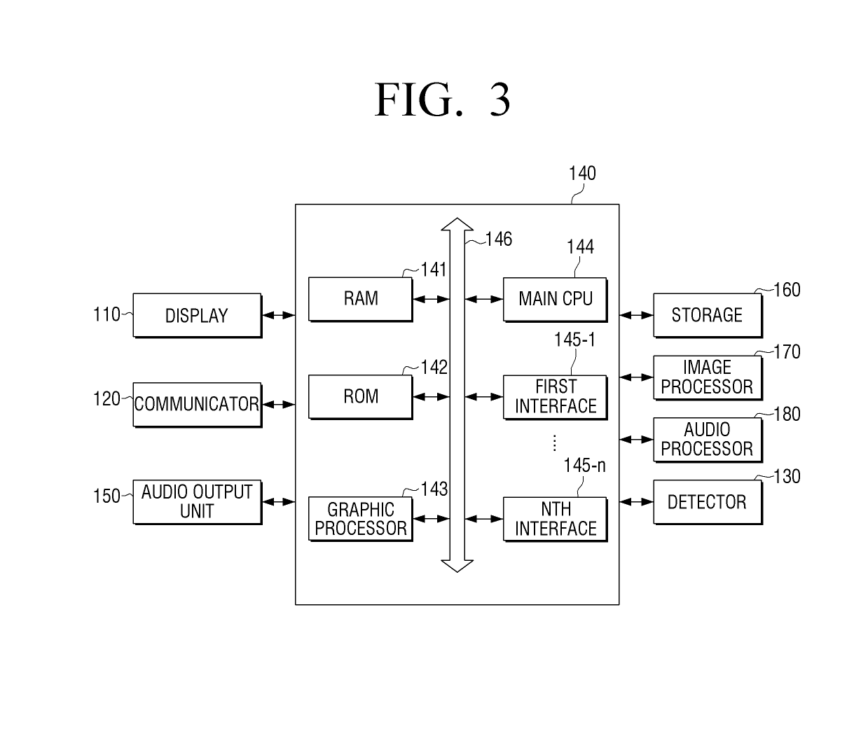

FIG. 3 is a block diagram illustrating configuration of the user terminal device 100 in detail. As illustrated in FIG. 3, the user terminal device 100 includes the display 110, a communicator 120, an audio output unit 150, a storage 160, an image processor 170, an audio processor 180, a detector 130, and a controller 140. In this case, the display 110 may be realized as a touch screen that also includes the detector 130.

FIG. 3 illustrates various components comprehensively, assuming that the user terminal device 100 is an apparatus having various functions such as a content providing function, a display function, a communication function, etc. Accordingly, depending on exemplary embodiments, a part of the components illustrated in FIG. 3 may be omitted or changed, or other components may be further added.

The display 110 displays at least one of a video frame which is generated as the image processor 170 processes image data received through the communicator 120 and various screens generated by a graphic processor 143. In particular, the display 110 may display at least one broadcast content received from the external apparatus 200. Specifically, if an image stream including a broadcast content is received, the display 110 may display a broadcast content processed by the image processor 170.

The communicator 120 performs communication with various types of external apparatuses according to various types of communication methods. The communicator 120 may include various components to provide for communication such as WiFi, Bluetooth, Near Field Communication (NFC), or other type of wireless communication. In this case, the WiFi, Bluetooth, and/or NFC communication may be implemented by hardware and/or software components that perform communication according to a WiFi method, a Bluetooth method, and/or an NFC method, respectively. The NFC communication may operate according to an NFC method that uses a 13.56 MHz band among various RF-ID frequency bands such as 135 kHz, 13.56 MHz, 433 MHz, 860˜960 MHz, 2.45 GHz, and so on. In the case of the WiFi communication or Bluetooth communication, various connection information such as SSID and a session key may be transmitted/received first for communication connection and then, various information may be transmitted/received. Further, wireless communication may be implemented by components that provide communication according to various communication standards such as IEEE, Zigbee, 3^{rd} Generation (3G), 3^{rd} Generation Partnership Project (3GPP), Long Term Evolution (LTE) and so on.

In particular, the communicator 120 may receive an image stream including a broadcast content from the first external apparatus 200. In addition, the communicator 120 may transmit information regarding an image content that a user wishes to watch through the first external apparatus 200 to the first external apparatus 200 according to a touch gesture.

Further, the communicator 120 may receive various image contents such as a VOD content from an external server.

The audio output unit 150 outputs not only various audio data which is processed in many ways such as decoding, amplification, and noise filtering by the audio processor 180 but also various alarm sounds or voice messages. In particular, if the first external apparatus 200 displays a plurality of image contents, the audio output unit 150 may output an audio corresponding to one image content selected by a user from among a plurality of image contents.

The storage 160 stores various modules to drive the user terminal device 100. For example, the storage 160 may store software including a base module, a sensing module, a communication module, a presentation module, a web browser module, and a service module. Here, the base module refers to a basic module which processes a signal transmitted from each hardware included in the user terminal device 100, and transmits the processed signal to an upper layer module. The sensing module is a module that collects information from various sensors, and analyzes and manages the collected information. The sensing module may include a face recognition module, a voice recognition module, a motion recognition module, and an NFC recognition module, and so on. The presentation module is a module to compose a display screen. The presentation module may include a multimedia module for reproducing and outputting multimedia contents, and a user interface (UI) rendering module for UI and graphic processing. The communication module is a module to perform communication with an external device. The web browser module is a module to perform web browsing and access a web server. The service module is a module including various applications for providing various services.

As described above, the storage 160 may include various program modules, but some of the various program modules may be omitted or changed, or other program modules may be added according to the type and characteristics of the user terminal device 100. For example, if the above-described user terminal device 100 is realized as a smart phone, the base module may further include a location determination module to determine a Global Positioning System (GPS)-based location, and the sensing module may further include a sensing module to sense the motions of a user.

In addition, the storage 160 may include a buffer to store an image content temporarily so that the user terminal device 100 and the external apparatus 200 can be synchronized to reproduce the image content. The image content stored in the buffer may be output to the display 110 according to time stamp information of the image content. In addition, the storage 160 may store command data to control the external apparatus 200. The command data may be mapped to each multi-touch gesture on one-on-one basis.

The image processor 170 processes an image stream including an image content received through the communicator 120. The image processor 170 may perform various image processing such as decoding, multiplexing, scaling, noise filtering, frame rate conversion, resolution conversion, etc. with respect to an image stream.

The audio processor 180 processes audio data of image contents. The audio processor 180 may perform various processing such as decoding, amplification, noise filtering, etc. with respect to audio data. The audio data processed by the audio processor 180 may be output to the audio output unit 150.

The detector 130 may detect various touch gestures to control the configuration of the user terminal device 100. In particular, the detector 130 may be realized as a touch detector for detecting a user's touch gesture. In this case, the touch detector may be realized as a touch screen that is provided with the display 110.

The controller 140 controls the overall operations of the user terminal device 100 using various programs stored in the storage 160.

As illustrated in FIG. 3, the controller 140 includes a random access memory (RAM) 141, a read only memory (ROM) 142, a graphic processor 143, a main central processing unit (CPU) 144, a first to an nth interface 145-1˜145-n, and a bus 146. In this case, the RAM 141, the ROM 142, the graphic processor 143, the main CPU 144, the first to the nth interface 145-1˜145-n, etc. may be interconnected through the bus 146.

The ROM 142 stores a set of commands for system booting. If a turn-on command is input and thus, power is supplied, the main CPU 144 copies an operating system (O/S) stored in the storage 160 in the RAM 141 according to a command stored in the ROM 142, and boots a system by executing the O/S. When the booting is completed, the main CPU 144 copies various application programs stored in the storage 160 in the RAM 141, and executes the application programs copied in the RAM 141 to perform various operations.

The graphic processor 143 generates a screen including various objects such as a pointer, an icon, an image, a text, etc. using an computing unit (not shown) and a rendering unit (not shown). The computing unit computes property values such as coordinates, shape, size, and color of each object to be displayed according to the layout of the screen using a control command received from the input unit. The rendering unit generates a screen with various layouts including objects based on the property values computed by the computing unit. The screen generated by the rendering unit is displayed in a display area of the display 110.

The main CPU 144 accesses the storage 160, and performs booting using the O/S stored in the storage 160. The main CPU 144 performs various operations using various programs, contents, data, etc. stored in the storage 160.

The first to the nth interface 145-1˜145-n are connected to the above-described various elements. One of the above interface may be a network interface which is connected to an external apparatus via network.

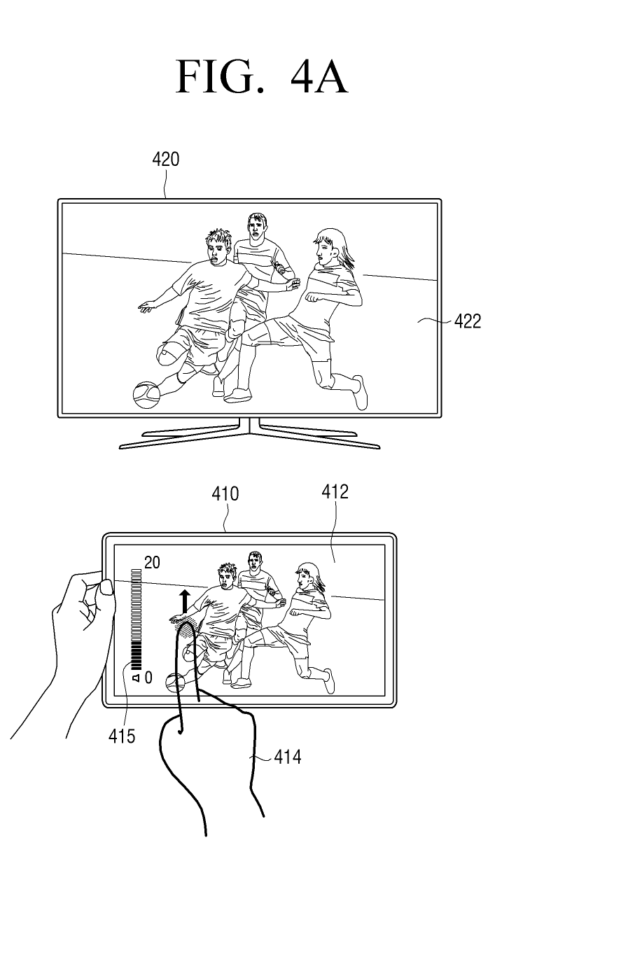

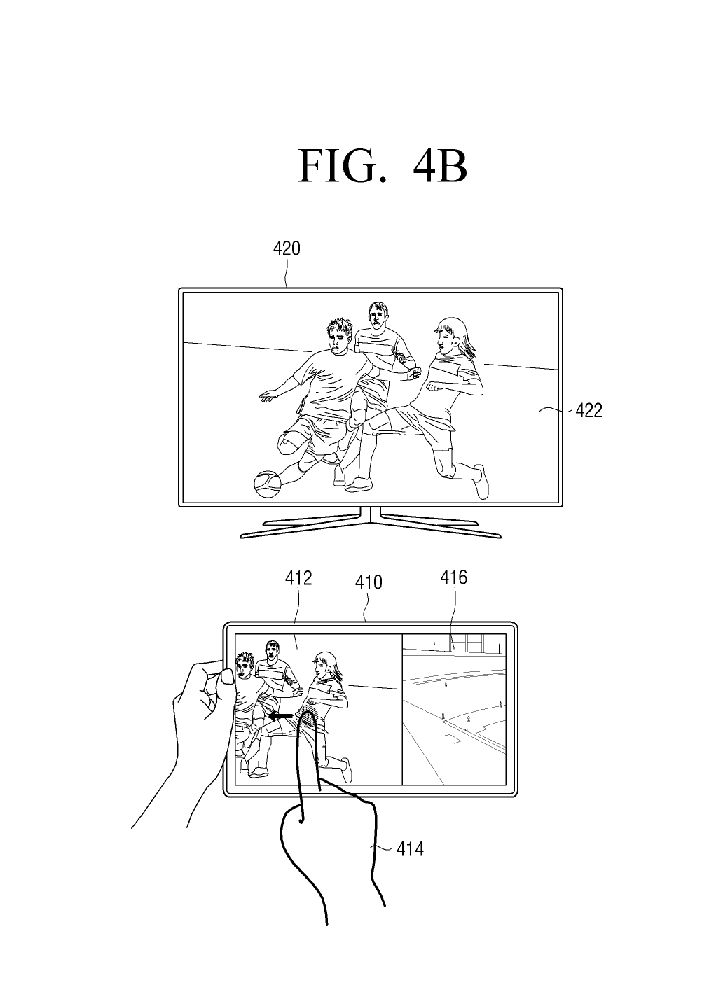

Hereinafter, the functions of the controller 140 will be described in greater detail with reference to FIGS. 4A to 11. The image content referred to in connection with the exemplary embodiments in this specification may refer to broadcast content, such as television broadcast programming received by satellite, cable or other broadcast system. The image content may also include streaming media received from an internet connection as well locally stored content such as DVD or Blu-ray content.

FIGS. 4A and 4B are views illustrating a screen which is displayed on a user terminal device 410 and a display of a first external apparatus 420 when a single-touch gesture is detected through the detector 130 according to an exemplary embodiment. Here, the display 110 of the user terminal device may include a touch detector. The first external apparatus 200 may be a display apparatus.

Referring to FIG. 4A, a first image content 412 and a graphic object 415 representing the level of volume are displayed on the user terminal device 410. The first external apparatus 420 displays a first image content 422.

The first image content 412 displayed on the user terminal device 410 and the first image content 422 displayed on the first external apparatus 420 may be synchronized with each other and reproduced. The first image content 412 displayed on the user terminal device 410 and the first image content 422 displayed on the first external apparatus 420 may be the same image content that is reproduced on both the user terminal device and first external apparatus. If a touch gesture is detected by the detector 130 while the first image content item 412 is displayed on the user terminal device 410, the controller 140 may determine whether the detected touch gesture is a single-touch gesture or a multi-touch gesture. If the touch gesture is determined to be a single-touch gesture, the controller 140 may control the user terminal device 410, and if the touch gesture is determined to be a multi-touch gesture, the controller 140 may control the communicator 120 to transmit data to the first external apparatus 200 for controlling the first external apparatus 200.

Alternatively, if the detected touch gesture is determined to be a single-touch gesture, the controller 140 may control the audio output unit 150 to adjust a volume level of the first image content which is being displayed according to the single-touch gesture or control the display 110 to change the location of reproduction or change the current channel to another channel. In addition, a corresponding graphic object may be displayed on the display 110 of the user terminal device 410 according to the single-touch gesture.

For example, if a user touches the display 110 with one finger 414 while the first image content is displayed and moves the finger in an upward direction while maintaining the touch, the controller 140 may control the audio output unit 150 to increase a volume level of the first image content that is reproduced in the user terminal device 100. In other words, if a user drags a finger from bottom to top, the volume level of the user terminal device increases, and a graphic object 415 representing the level of the volume may be displayed on the display 110 of the user terminal device 410. The first external apparatus 420 keeps displaying the first image content 422 without any change in the volume. If the user drags a finger from top to bottom, the volume level of the user terminal device 410 may decrease.

Referring to FIG. 4B, the user terminal device 410 displays a part of the first image content item 412 and a part of a second image content 416 on the same screen. FIG. 4B illustrates the process of changing from the first image content 412 to the second image content 416 in response to a user's single-touch gesture while the first image content 412 is displayed on the user terminal device 410. Specifically, the process of changing from the first image content 412 to the second image content 416 in response to a left or right drag gesture using one finger is illustrated (in this case, a user dragging one finger to the left). The first external apparatus 420 displays the first image content 422.

If a user touches the display 110 using one finger while the first image content 412 is displayed on the user terminal device 410 and moves the finger in a left or right direction while maintaining the touch, the controller 140 may change a current channel to another channel. In other words, the user terminal device 410 may change the first image content 412 that is being displayed on the display 110 to the second image content 416 of another channel according to the user's flick, drag, or swipe gesture. In this case, the first external apparatus 420 keeps displaying the first image content 412, and there is no change in a display 230 according to the single-touch gesture.

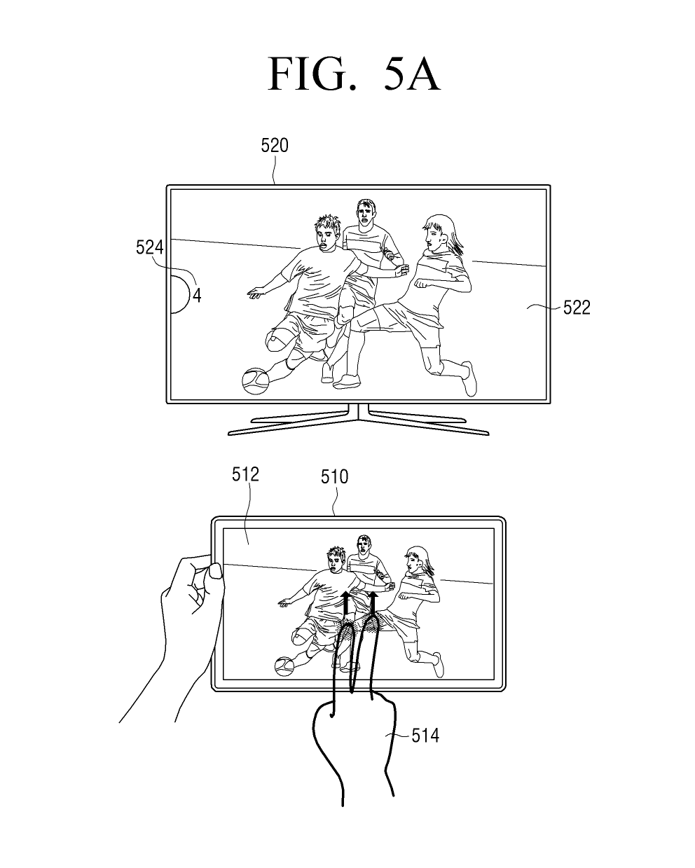

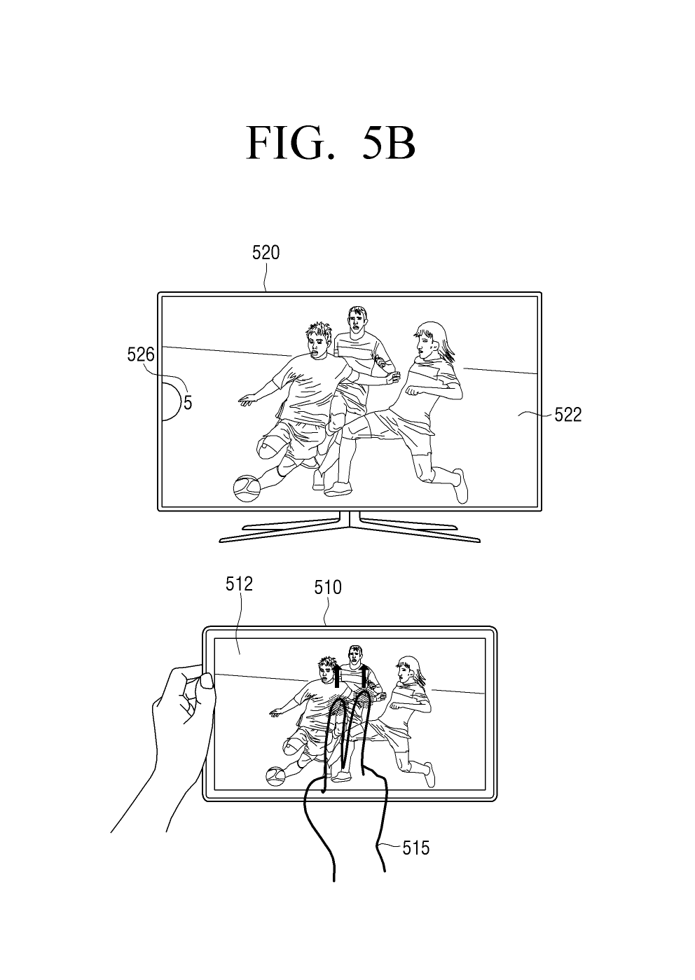

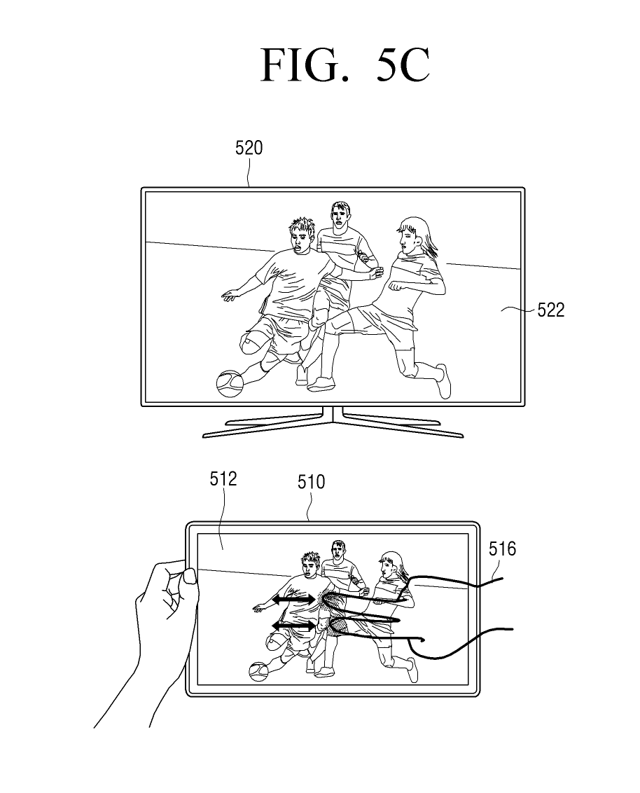

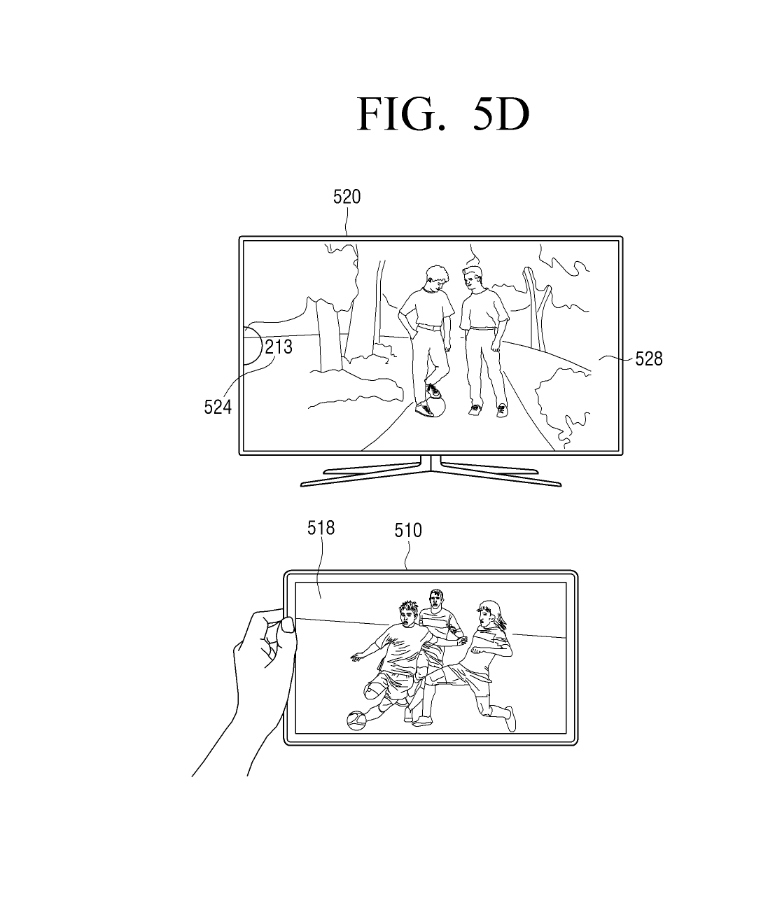

FIGS. 5A and 5B are views illustrating a screen that is displayed on a user terminal device 510 and a display of a first external apparatus 520 when the detector 130 of the user terminal device detects a multi-touch gesture according to an exemplary embodiment. Specifically, if a user drags the display 110 of the user terminal device 510, a volume level of the first external apparatus 510 increases gradually, and graphic objects 524, 526 representing the level of the volume are displayed on the display 230 of the first external apparatus 420.

Referring to FIGS. 5A and 5B, the user terminal device 510 displays a first image content 512. The first external apparatus 520 displays a first image content 522. The first image content 512 displayed on the user terminal device 510 may be synchronized with the first image content 522 displayed on the first external apparatus 520 and reproduced. In other words, the reproduction of the first image content 512 displayed on the user terminal device 510 is synchronized with the reproduction of the first image content 522 displayed on the first external apparatus 520 such that the same point in time of the content is simultaneously displayed on both user terminal device 510 and first external apparatus 520. For example, if the user terminal device 510 is reproducing position ‘A’ of the first image content item 512, the first external apparatus 520 may also reproduce corresponding position ‘A’ of the first image content item 522 at substantially the same time.

If a touch gesture is detected through the detector 130 while the first image content 512 is displayed on the user terminal device 510, the controller 140 may determine whether the detected gesture is a single-touch or a multi-touch. If it is determined that the detected touch gesture is a single-touch gesture, the controller 140 controls the user terminal device 510, and if it is determined that the detected touch gesture is a multi-touch gesture, the controller 140 may control the communicator 120 to transmit data for controlling the first external apparatus 520. If a multi-touch gesture is detected through the detector 130, the controller 140 may control the communicator 120 to transmit command data for controlling the first external apparatus 520 to the first external apparatus 520. If the multi-touch gesture is a drag gesture using two fingers in an upward or downward direction, the controller 140 may control the communicator 120 to transmit data for controlling a volume level of the first external apparatus 520. The drag gesture using two fingers in an upward or downward direction refers to a motion where a user touches the display 110 with his or her two fingers and moves the fingers from bottom to top or from top to bottom while maintaining the touch.

For example, if a drag or scroll motion using two fingers is performed in a bottom to top direction while the first image content 512 is displayed on the display 110 of the user terminal device 510, the controller 140 may control the communicator 120 to transmit command data for controlling a volume level of the first external apparatus 520 to the first external apparatus 520. The first external apparatus 520 may receive the command data and adjust the volume level of the first external apparatus 520. In other words, if a user touches and drags the display 110 of the user terminal device 510 from bottom to top, the volume level of the first external apparatus 520 may increase, and if the user drags the display 110 of the user terminal device 510 from top to bottom, the volume level of the first external apparatus 520 may decrease. The drag motion refers to a motion where a user touches the display 110 with a finger and moves the finger while maintaining the touch. The scroll motion is similar to the drag motion. The scroll motion refers to a motion where a user touches the display 110 with a finger and moves the finger while maintaining the touch.

In addition, graphic objects 524, 526 representing the level of volume may be displayed on the display 230 of the first external apparatus 520 according to a user's drag motion using two fingers. Depending on the length of the drag using two fingers, the graphic objects 524, 526 displayed on the display 230 of the first external apparatus 520 may be changed and displayed. For example, if a user touches and drags the display 110 of the user terminal device 510 using two fingers, the graphic object 524 may be displayed on the display 230 of the first external apparatus 520. If the user keeps performing the drag motion, the graphic object 526 may be displayed on the display 230 of the first external apparatus 520.

FIGS. 5C and 5D are views illustrating that a channel of the first external apparatus 520 is changed by a left or right gesture of two fingers while the first image content 512 is displayed on the user terminal device 510.

Referring to FIG. 5C, the user terminal device 510 displays the first image content 512. The first external apparatus 520 displays the first image content item 522. The first image content 512 displayed on the user terminal device 510 and first image content 522 displayed on the first external apparatus 520 may be synchronized with each other and reproduced. In other words, the reproduction of the first image content 512 displayed on the user terminal device 510 is synchronized with the reproduction of the first image content 522 displayed on the first external apparatus 520 such that the same point in time of the content is simultaneously displayed on both user terminal device 510 and first external apparatus 520. For example, if the user terminal device 510 is reproducing position ‘A’ of the first image content 512, the first external apparatus 520 may also reproduce corresponding position ‘A’ of the first image content 522 at substantially the same time.

If a touch gesture is detected through the detector 130 while the first image content 512 is displayed on the user terminal device 510, the controller 140 may determine whether the detected gesture is a single-touch or a multi-touch. If it is determined that the detected touch gesture is a single-touch gesture, the controller 140 controls the user terminal device 510, and if it is determined that the detected touch gesture is a multi-touch gesture, the controller 140 may control the communicator 120 to transmit data for controlling the first external apparatus 520. If a multi-touch gesture is detected through the detector 130, the controller 140 may control the communicator 120 to transmit command data for controlling the first external apparatus 520 to the first external apparatus 520. For example, if a swipe or drag motion using two fingers is performed in a left or right direction while the first image content 512 is displayed on the display 110 of the user terminal device 510, the user terminal device 510 may control the communicator 120 to transmit command data to the first external apparatus 520 for changing a channel of the first external apparatus 520. The first external apparatus 520 may receive the command data and change the channel of the first external apparatus 520. If a user swipes the display 110 of the user terminal device 510 in a left direction, the channel number of the first external apparatus 520 may increase, and if the user swipes the display 110 of the user terminal device 510 in a right direction, the channel number of the first external apparatus 520 may decrease. Alternatively, if a user swipes the display 110 of the user terminal device 510 in a left direction, the channel number of the first external apparatus 520 may decrease, and if the user swipes the display 110 of the user terminal device 510 in a right direction, the channel number of the first external apparatus 520 may increase. The channels may be changed according to a user's swipe or drag motion.

Referring to FIG. 5D, the user terminal device 510 displays a first image content 518. The first external apparatus 520 displays a second image content 528. If a user's swipe motion using two fingers is performed while the first image content 518 is displayed on the user terminal device 510, the channel of the first external apparatus 520 is changed and accordingly, the first image content item 522 that is being displayed (see FIG. 5C) may be changed to the second image content 528. In addition, the display 230 of the first external apparatus 520 may display the number of the changed channel 524. In this case, the user terminal device 510 may keep displaying the first image content 518.

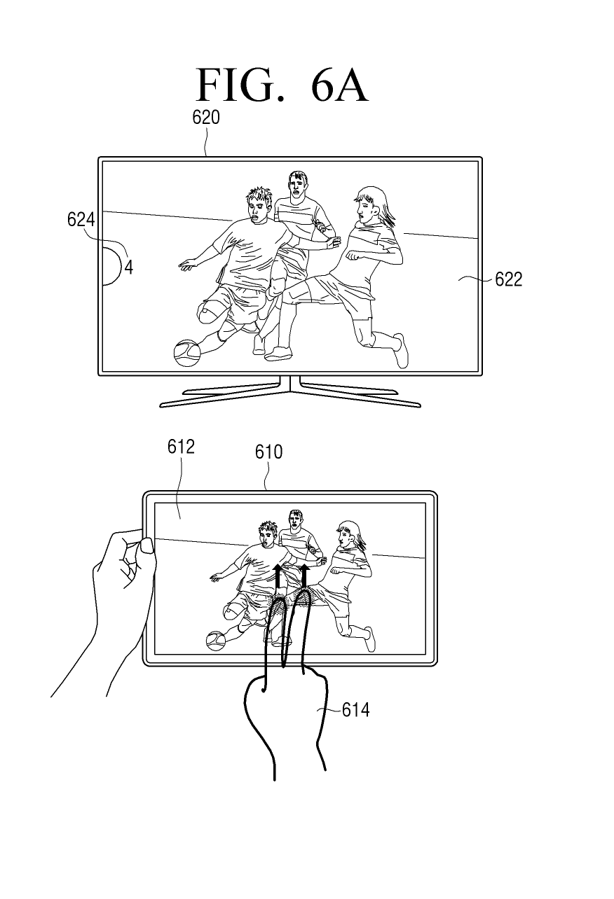

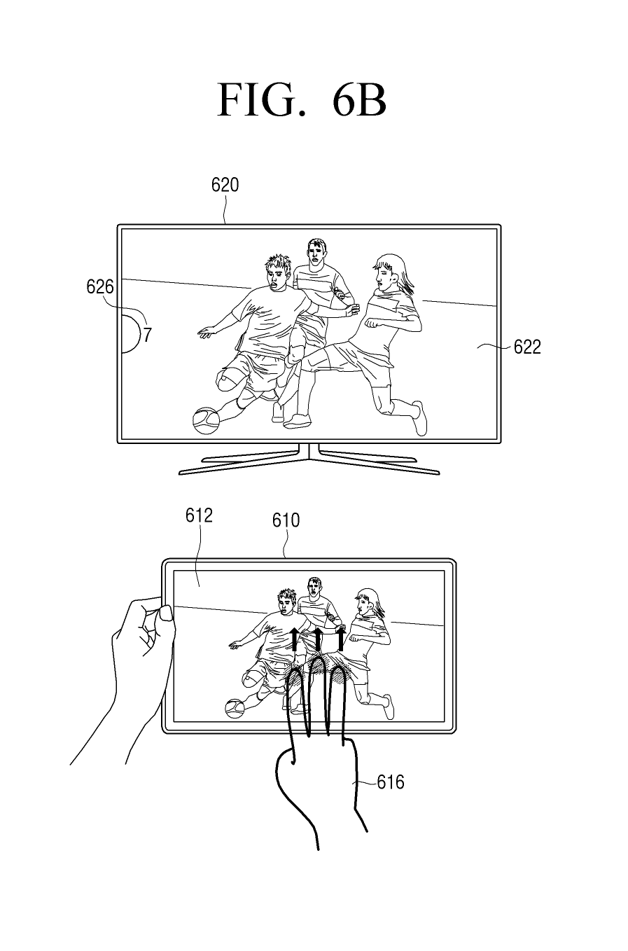

FIGS. 6A and 6B are views illustrating a first external apparatus 620 that is controlled differently according to whether a gesture of two fingers or three fingers is detected on a user terminal device 610. Referring to FIG. 6A, the user terminal device 610 displays a first image content 612. The first external apparatus 620 displays a first image content 622 and a graphic object 624 representing a volume level. If a drag gesture using two fingers 614 is detected by the detector 130 while the first image content 612 is displayed on the user terminal device 610, the controller 140 may control the communicator 120 to transmit command data for controlling the first external apparatus 620 to the first external apparatus 620. As the drag motion continues, the controller 140 may keep controlling the first external apparatus 620. In addition, the controller 140 may control the communicator 120 to transmit command data for adjusting the amount of change of the volume level or channel of the first external apparatus 620 according to the number of fingers touching the display 110. In addition, if a multi-touch gesture is detected, the controller 140 may control the communicator 120 to transmit data for adjusting the amount of change of the volume level or channel of the first external apparatus 620 based on the number of fingers used in the multi-touch that is detected. In other words, the controller 140 may control the communicator 120 to transmit command data for adjusting the amount of change of the volume level or channel of the first external apparatus 620 based on the number of fingers touching the display 110. In addition, the controller 140 may control the communicator 120 to transmit command data for adjusting the amount of change of the volume level or channel of the first external apparatus 620 according to the number of touch points of the multi-touch gesture.

Further, if the multi-touch gesture is a drag gesture using two fingers in an upwards or downwards direction, the controller 140 may transmit data for changing the volume level of the first external apparatus 620 in a sequential manner, and if the multi-touch gesture is a drag gesture using three fingers in an up-and-down direction, the controller 140 may control the communicator 120 to transmit command data for changing the volume of the first external apparatus 620 in a non-sequential manner. According to an exemplary embodiment, changing the volume level or channel in a sequential manner would involve changing from one level or channel to the next level or channel, whereas a non-sequential manner would involve changing the level or channel by skipping some levels or channels.

If the multi-touch gesture is a swipe gesture using two fingers in an upward or downward direction, the controller 140 may control the communicator 120 to transmit data for changing the volume level of the first external apparatus 620 in a sequential manner, and if the multi-touch gesture is a swipe gesture using three fingers in an upward or downward direction, the controller 140 may control the communicator 120 to transmit command data for changing the volume level of the first external apparatus 620 in a non-sequential manner.

If the multi-touch gesture is a scroll gesture using two fingers in an upward or downward direction, the controller 140 may control the communicator 120 to transmit data for changing the volume of the first external apparatus 620 in a sequential manner, and if the multi-touch gesture is a scroll gesture using three fingers in an up-and-down direction, the controller 140 may control the communicator 120 to transmit command data for changing the volume of the first external apparatus 620 in a non-sequential manner.

If the multi-touch gesture is a drag gesture using two fingers in a left or right direction, the controller 140 may control the communicator 120 to transmit data for changing the channel of the first external apparatus 620 in a sequential manner, and if the multi-touch gesture is a drag gesture using three fingers in a left or right direction, the controller 140 may control the communicator 120 to transmit command data for changing the channel of the first external apparatus 620 in a non-sequential manner.

If the multi-touch gesture is a swipe gesture using two fingers in a left or right direction, the controller 140 may control the communicator 120 to transmit data for changing the channel of the first external apparatus 620 in a sequential manner, and if the multi-touch gesture is a swipe gesture using three fingers in a left or right direction, the controller 140 may control the communicator 120 to transmit command data for changing the channel of the first external apparatus 620 in a non-sequential manner.

In addition, if the multi-touch gesture is a scroll gesture using two fingers in a left or right direction, the controller 140 may control the communicator 120 to transmit data for changing the channel of the first external apparatus 620 in a sequential manner, and if the multi-touch gesture is a scroll gesture using three fingers in a left or right direction, the controller 140 may control the communicator 120 to transmit command data for changing the channel of the first external apparatus 620 in a non-sequential manner.

For example, if a user drags the display 110 of the user terminal device 610 using two fingers in an upward direction, the controller 140 may control the communicator 120 to transmit command data for increasing the volume level of the first external apparatus 620 in a sequential manner, that is, in the order of 0, 1, 2, 3, 4, . . . to the first external apparatus 620. If the user drags the display 110 of the user terminal device 610 using three fingers in an upward direction, the controller 140 may control the communicator 120 to transmit command data for increasing the volume level of the first external apparatus 620 in a non-sequential manner, that is, in the order of 1, 3, 5, 7, . . . to the first external apparatus 620. If the user drags the display 110 of the user terminal device 610 using four or five fingers, the controller 140 may control the communicator 120 to transmit command data for changing the volume level of the first external apparatus 620 by a larger interval to the first external apparatus 620.

If a user swipes the display 110 of the user terminal device 610 using two fingers in a right direction, the controller 140 may control the communicator 120 to transmit command data for changing the channel of the first external apparatus 620 in a sequential manner, that is, in the order of 0, 1, 2, 3, 4, . . . to the first external apparatus 620. If the user swipes the display 110 of the user terminal device 610 using three fingers in an upward direction, the controller 140 may control the communicator 120 to transmit command data for changing the channel of the first external apparatus 620 in a non-sequential manner, that is, in the order of 1, 3, 5, 7, . . . to the first external apparatus 620. If the user swipes the display 110 of the user terminal device 610 using four or five fingers in a left or right direction, the controller 140 may control the communicator 120 to transmit command data for changing the channel of the first external apparatus 620 by a larger interval to the first external apparatus 620.

Referring to FIG. 6B, a drag motion using three fingers 616 is illustrated while the first image content 612 is displayed on the user terminal device 610. The first external apparatus 620 displays the first image content 622 and a graphic object 626 representing the level of volume. In response to a drag gesture in an upward direction by the three fingers 616 detected on the user terminal device 610, the volume level may increase by skipping one level in the first external apparatus 620. In addition, the graphic object 626 representing the level of volume may be displayed on the display 230 of the first external apparatus 620.

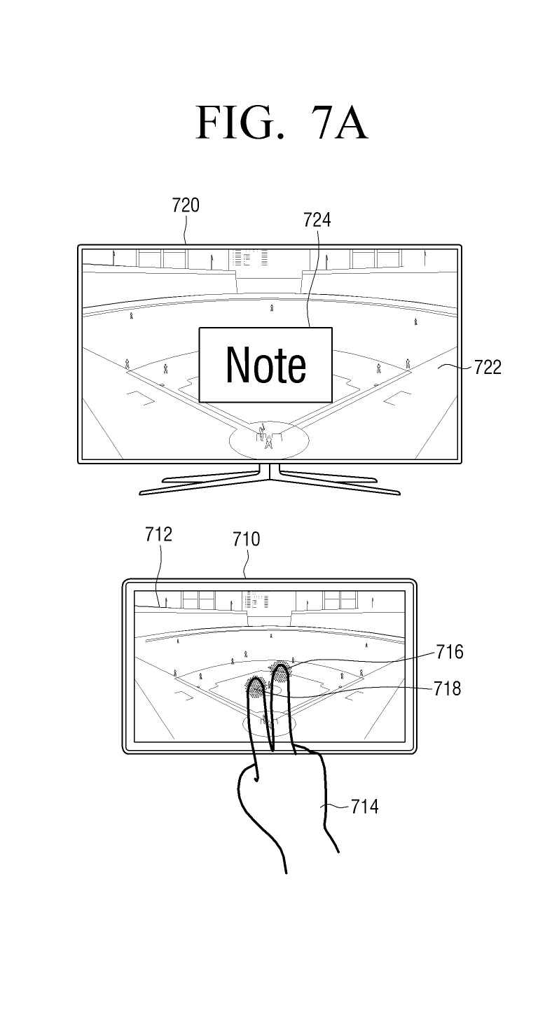

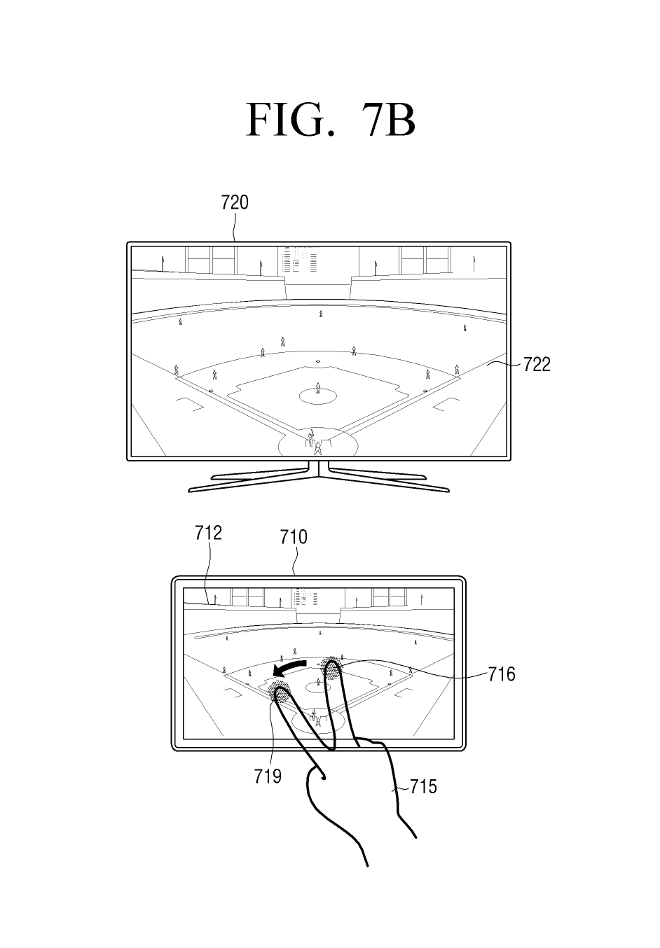

FIGS. 7A and 7B are views illustrating a first layer displayed on the display 230 of a first external apparatus 720 is removed from the display 230 according to a multi-touch gesture detected through the detector 130 of a user terminal device 710 according to another exemplary embodiment.

Referring to FIG. 7A, the first external apparatus 720 displays a first image content 722 and a first layer 724. The first layer 724 may be a graphic object. The first layer 724 may be displayed to be overlapped with the first image content 722. The first layer 724 may be a menu screen, a screen representing information regarding the first image content 722, or a screen for providing information regarding the state of the first external apparatus 720 to a user.

The user terminal device 710 displays a first image content 712. The first image content 712 and a first image content 722 may be synchronized with each other and reproduced. If a multi-touch gesture detected through the detector 130 is a rotation gesture using two fingers, the controller 140 may remove a graphic object displayed on the first external apparatus 720. The graphic object may be the first layer 724. The rotation gesture using two fingers may be a motion of fixing one finger and moving the other finger. For example, if a user fixes one finger 716 on the display 110 and moves the other finger 718, the controller 140 may detect the user touch, and control the communicator 120 to transmit command data to remove the first layer 724 displayed on the display 230 of the first external apparatus 720. The first external apparatus 720 removes the first layer 724 displayed on the display 230 in response to the command data.

In other words, the controller 140 may remove the first layer 724 displayed on the first external apparatus 720 in response to a touch gesture using one finger and a touch move gesture using the other finger detected on the user terminal device 710.

FIG. 7B illustrates the first image content 712 displayed on the user terminal device 710, the location of one finger 716 being fixed, and the other finger 719 being moved in a left direction in comparison with the corresponding location in FIG. 7A. The first external apparatus 720 displays the first image content 722. The controller 140 of the user terminal device 710 may detect a touch by one finger and a touch move 714 by the other finger detected on the display 110, and control the communicator 120 to transmit command data to the first external apparatus 720 to remove the first layer 724 displayed on the first external apparatus 720. In response to the command data, the first layer 724 may be removed and thus, the first image content 722 may appear on the display 230 of the first external apparatus 720.

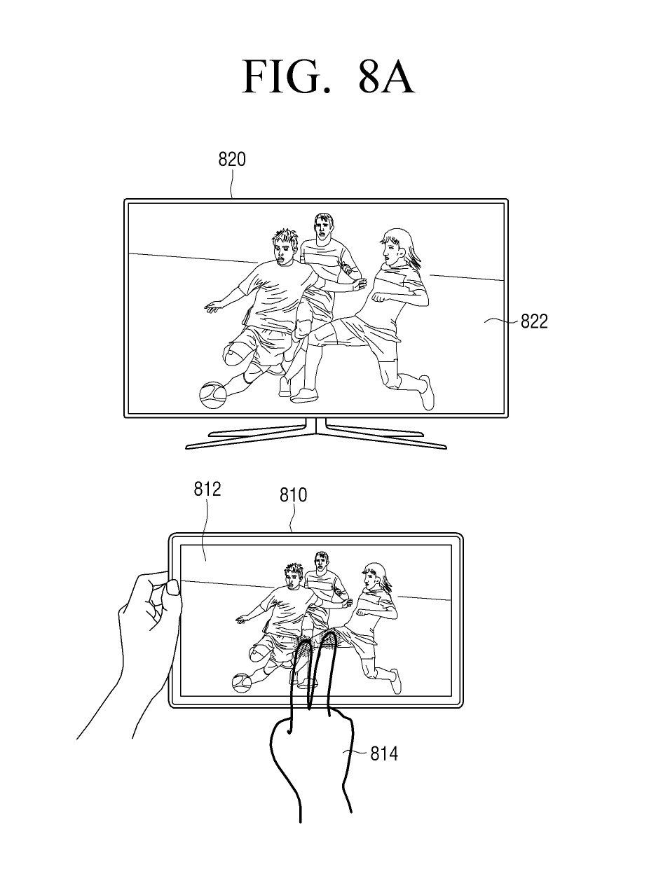

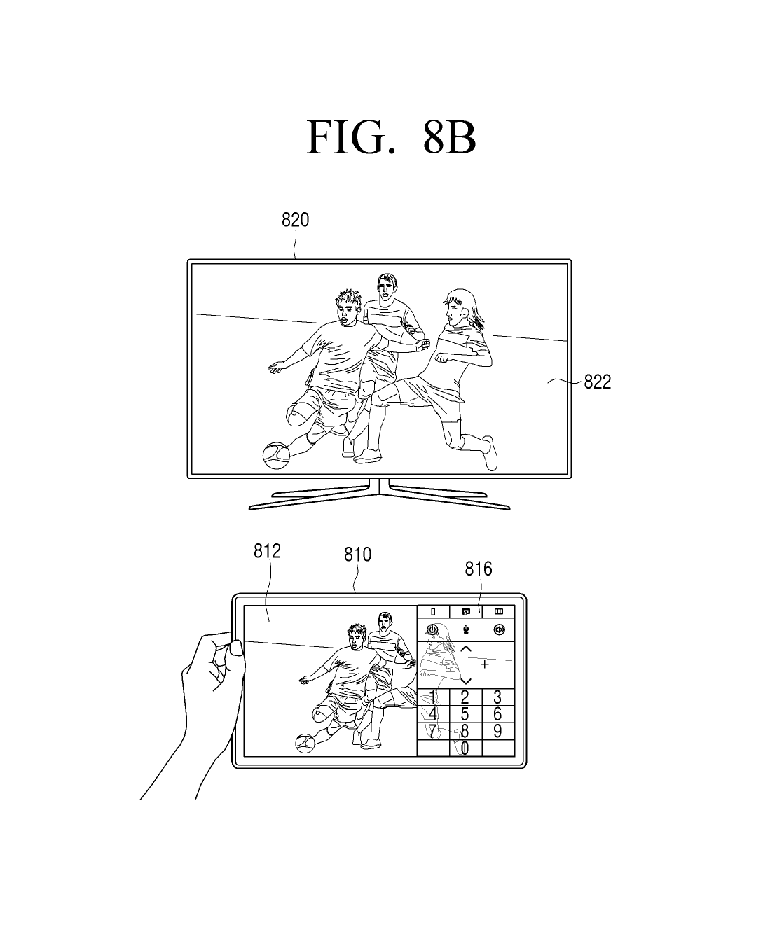

FIGS. 8A and 8B are views illustrating another exemplary embodiment in which a virtual remote controller 816 to control a first external apparatus 820 is displayed on a user terminal device 810 according to a multi-touch gesture detected through the detector of the user terminal device 810.

FIG. 8A illustrates that a first image content 812 and a virtual remote controller 816 are displayed on the user terminal device 810. The first external apparatus 820 displays a first image content 822. If a user touches the display 110 of the user terminal device 810 using two fingers 814 and maintains the touch for a predetermined time, the controller 140 may detect the user touch and display the virtual remote controller 816 on the display 110. The virtual remote controller 816 may display buttons to control the first external apparatus 820, such as a virtual keypad, virtual buttons for adjusting volume and channel settings, and so on. As a user touches a button included in the virtual remote controller 816, the controller 140 may control the communicator 120 to transmit command data corresponding to the button of the virtual remote controller to the first external apparatus 820.

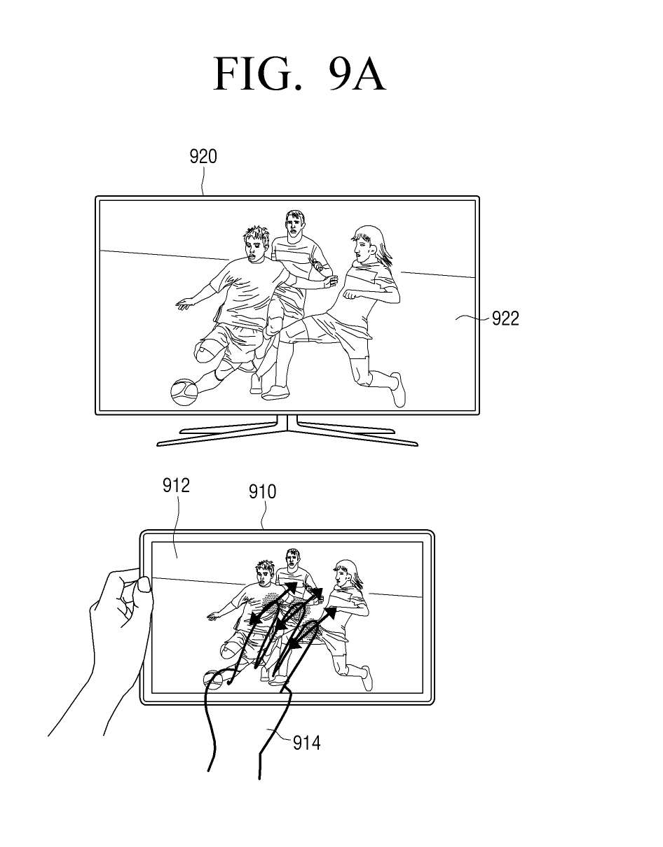

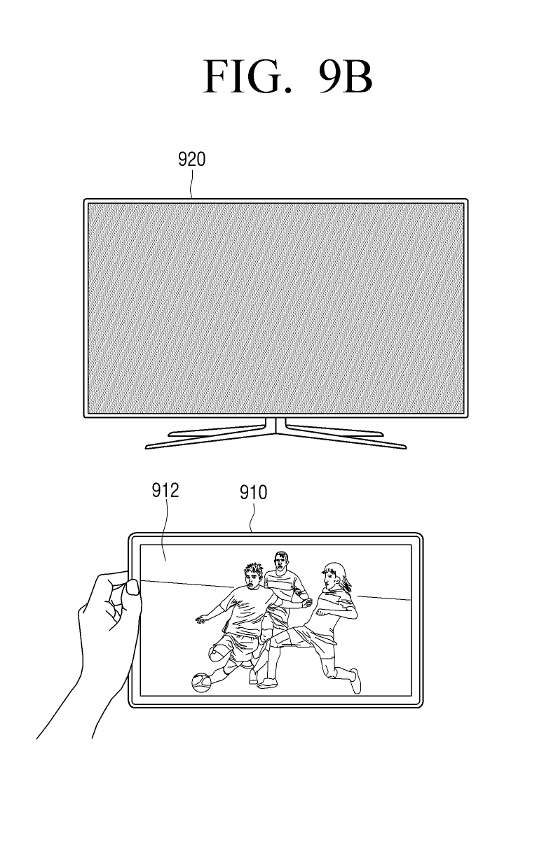

FIGS. 9A and 9B are views illustrating that a first external apparatus 920 is turned off according to a multi-touch gesture detected on a user terminal device 910 according to another exemplary embodiment.

FIG. 9A illustrates that a first image content 912 is displayed on the user terminal device 910. The first external apparatus 920 displays a first image content 922. The first image content 912 and the first image content 922 may be synchronized with each other and reproduced. If a drag gesture using three fingers 914 in a slant or diagonal direction is detected through the detector 130, the controller 140 may detect a touch and a touch motion of the three fingers 914, and control the communicator to transmit command data to turn off the first external apparatus 920 to the first external apparatus 920. The first external apparatus 920 may receive the command data and turn off the power accordingly.

In addition, if a swipe gesture using three fingers 914 in a slant or diagonal direction is detected on the user terminal device 910, the controller 140 may control the communicator 120 to transmit command data to turn off the first external apparatus 920 to the first external apparatus 920.

FIG. 9B illustrates that the screen of the first external apparatus 920 is turned off. The user terminal device 910 still displays the first image content 912. In response to a drag gesture using three fingers in a slant or diagonal direction being detected on the user terminal device 910, the controller 140 may control the communicator 120 to transmit command data to turn off the first external apparatus 920 to the first external apparatus 920. The first external apparatus 920 may receive the command data and turn off the first external apparatus 920. If the first external apparatus 920 is turned off, the power of the first external apparatus may be turned off. In addition, even if the first external apparatus 920 is turned off, the power of some blocks may still be turned on and communicate with the user terminal device 910. In this disclosure, a drag gesture using a user's three fingers in a slant or diagonal direction is taken as an example, but the same operation may be performed with respect to a drag gesture using three fingers in vertical and horizontal directions. In addition, the gesture is not limited to a drag gesture, and the same operation may be performed with respect to a swipe gesture or other similar gestures. Even if the first external apparatus 920 is turned off, the user terminal device 910 may keep displaying the first image content 912 on the display 110.

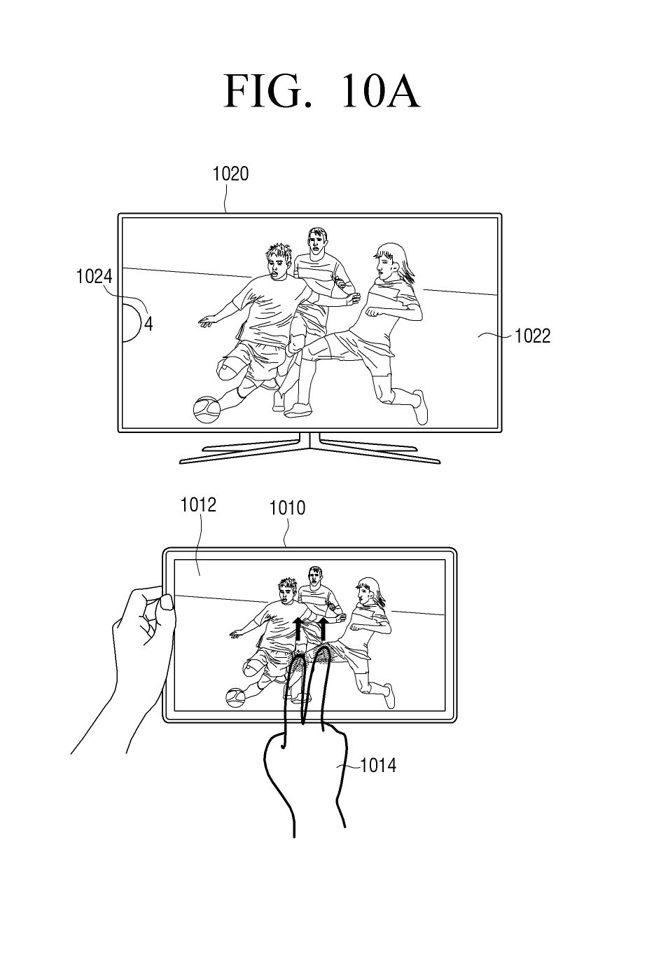

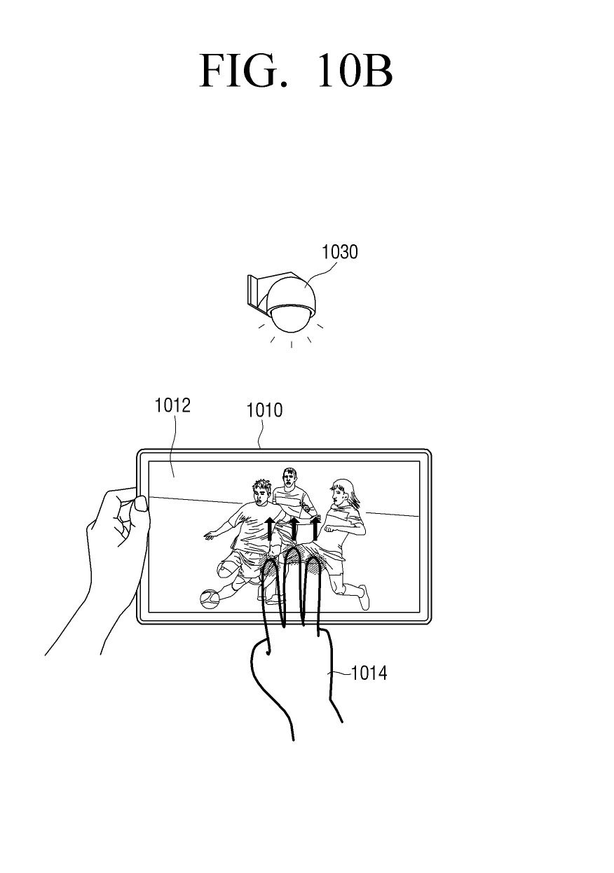

FIGS. 10A and 10B are views illustrating another exemplary embodiment in which a first external apparatus 1020 or a second external apparatus 1030 is controlled according to a multi-touch gesture of two fingers or three fingers detected through the detector 130 of a user terminal device 1010.

FIG. 10A illustrates that the user terminal device 1010 displays a first image content 1012. The first external apparatus 1020 displays a first image content 1022 and a graphic object 1024 representing the level of volume.

FIG. 10B illustrates that the user terminal device displays the first image content 1012. In addition, FIG. 10B illustrates the second external apparatus 1030 which can be controlled by the user terminal device 1010. In this case, the second external apparatus 1030 may be a lighting device.

If a user drags the display 110 of the user terminal device 1010 using a finger, the controller 140 may detect the drag motion through the detector 130 and determine whether the drag motion is a single-touch gesture using one finger or a multi-touch gesture using two or three fingers. If it is determined that the detected touch gesture is a single-touch gesture, the controller 140 may control the user terminal device 100. If it is determined that the detected touch gesture is a multi-touch gesture using two fingers, the controller 140 may control the communicator 120 to transmit command data to control the first external apparatus 1020 to the first external apparatus 1020. For example, if a user drags the display 100 of the user terminal device 1010 in an upward direction using two fingers, the controller 140 may control the communicator 120 to transmit command data to increase the volume level of the first external apparatus 1020 to the first external apparatus 1020. If a user drags the display 110 of the user terminal device 1010 in a downward direction using two fingers, the controller 114 may control the communicator 120 to transmit command data to decrease the volume level of the first external apparatus 1020 to the first external apparatus 1020. In addition, the controller 140 may use the length of the drag detected through the detector 130 of the user terminal device 1010 to adjust the volume level of the first external apparatus 1020 in accordance with the detected length. The length of the drag may be the distance that a finger moves.

If a drag gesture using three fingers is detected on the user terminal device 1010, the controller 140 may control the communicator 120 to transmit command data to control the second external apparatus 1030 to the second external apparatus 1030. In other words, the controller 140 may detect a drag gesture using three fingers on the display 100 of the user terminal device 1010 through the detector 130, and control the communicator 120 to transmit command data to control the second external apparatus 1030 to the second external apparatus 1030. For example, if the second external apparatus 1030 is a lighting device, the controller 140 may detect a drag gesture using three fingers through the detector 130 and control the communicator 120 to transmit command data to the lighting device to adjust the brightness of the lighting device. The lighting device which is the second external apparatus 1030 may adjust the brightness of lighting according to the length of the drag by three fingers detected on the user terminal device 1010.

In the above exemplary embodiment, a multi-touch gesture using two and three fingers has been described, but it is possible to control an external apparatus with respect to a multi-touch gesture using more than three fingers. In this case, a setting screen for registering an external apparatus to be controlled can be displayed on a user terminal device. A user may register a plurality of external apparatuses to be controlled on the setting screen.

Specifically, in response to a single-touch gesture detected on the user terminal device 1010, the controller 140 may control the user terminal device 1010, and in response to a multi-touch gesture detected on the user terminal device 1010, the controller may control at least one of a plurality of external apparatuses. In other words, in response to a multi-touch gesture using two fingers, the controller 140 may control the first external apparatus 1020, and in response to a multi-touch gesture using three fingers, the controller 140 may control the second external apparatus 1030. In addition, in response to a multi-touch gesture using four fingers, the controller 140 may control a third external apparatus.

The controller 140 may determine an external apparatus to be controlled according to the number of touch points touched on the display 100 of the user terminal device 1010 and a related gesture.

The controller 140 may control to perform the same function in the user terminal device 1010 and the first external apparatus 1020 with respect to the same gesture. In other words, the controller 140 may determine whether to control the user terminal device 1010 or the first external apparatus 1020 according to the number of touch points. In response to a gesture using one finger, the controller 140 may control to perform a first function in the user terminal device 1010, and in response to a gesture using two fingers, the controller 140 may control the communicator 120 to transmit command data to perform the first function in the first external apparatus 1020.

For example, the controller 140 may detect a drag gesture using one finger in a left or right direction on the display 110 of the user terminal device 1010, and change the channel of the user terminal device 1010. Alternatively, the controller 140 may detect a drag gesture using two fingers in a left and right direction on the display 110 of the user terminal device 101 through the detector 130, and change the channel of the first external apparatus 1020.

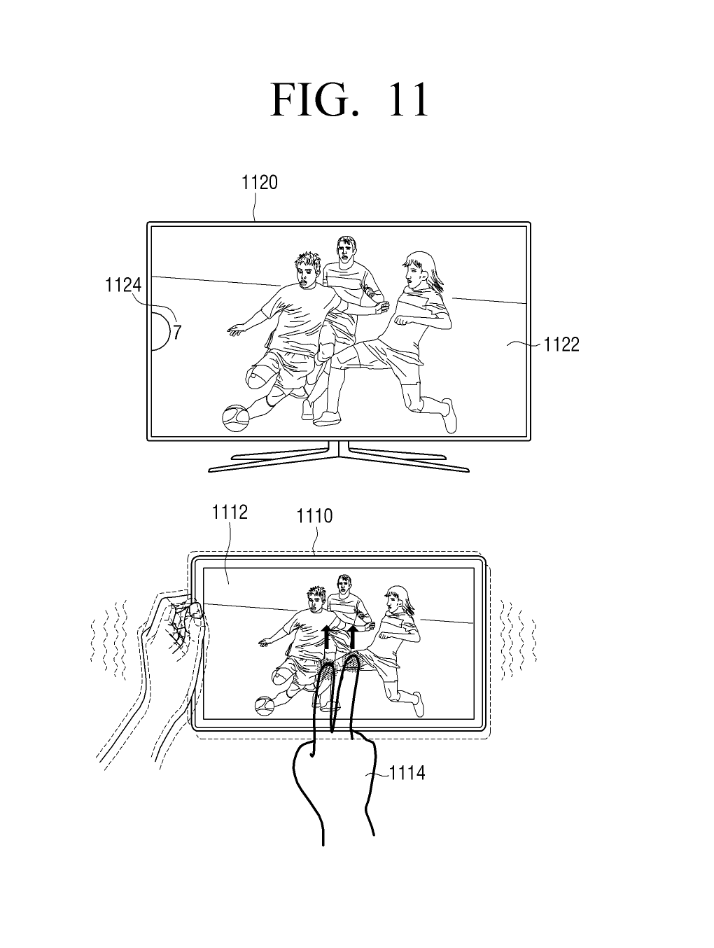

FIG. 11 is a view illustrating another exemplary embodiment in which a vibration feedback is generated as a multi-touch gesture is detected on a user terminal device. FIG. 11 illustrates that the user terminal device 1110 displays a first image content 1112. In response to a multi-touch gesture 1114, a vibration feedback may be generated on the user terminal device 1110. A first external apparatus 1120 displays a first image content 1122 and a graphic object 1124 representing the level volume. If a single-touch gesture is detected through the detector 130, the controller 140 controls the user terminal device 110, and if the multi-touch gesture 1114 is detected, the controller 140 may control the communicator 120 to transmit command data corresponding to the multi-touch gesture to the first external apparatus 1120 and generate a vibration feedback corresponding to the multi-touch gesture 1114. In addition, the controller 140 may provide a feedback to the user terminal device 1110 in response to a multi-touch gesture detected on the user terminal device, and control the communicator 120 to transmit command data for controlling the first external apparatus 1120 to the first external apparatus 1120. The feedback may be an audio, a video and/or a vibration feedback.

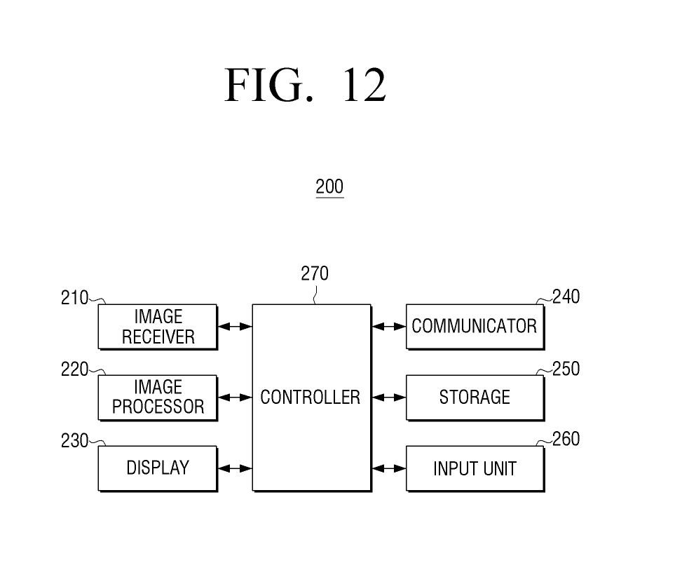

FIG. 12 is a block diagram illustrating an internal configuration of a first external apparatus 200 according to another exemplary embodiment. The first external apparatus 200 will be described in greater detail with reference to FIG. 12. The first external apparatus 200 may be a display apparatus or an audio apparatus. Alternatively, the first external apparatus 200 may be a lighting apparatus. Here, a display apparatus is taken as an example of the first external apparatus 200. As illustrated in FIG. 12, the first external apparatus 200 includes an image receiver 210, an image processor 220, a display 230, a communicator 240, a storage 250, an input unit 260, and a controller 270.

The image receiver 210 receives an image stream from outside. In particular, the image receiver 210 may receive an image stream including a broadcast content from an external broadcasting station (such as a satellite, cable, or other broadcast) and an image stream including a VOD image content from an external server.

In order to display a plurality of broadcast contents or transmit a plurality of broadcast contents to the external user terminal device 100, the image receiver 210 may include a plurality of tuners. In this case, the image receiver 210 may include two tuners, but this is only an example. The image receiver 210 may alternatively include three tuners or more.

The image processor 220 may process an image stream received through the image receiver 210. Specifically, the image processor 220 may process an image stream so that an image content can be displayed.

The display 230 displays at least one image content under the control of the controller 270.

The communicator 240 communicates with various external apparatuses. In particular, the communicator 240 may communicate with the external user terminal device 100. Specifically, the communicator 240 may transmit an image content to the user terminal device 100, and receive information regarding an image content including a control command from the user terminal device 100.

The storage 250 stores various data and programs to drive the external apparatus 200. In particular, the storage 250 may include a buffer for storing an image content temporarily so that the display of the image content can be synchronized with the user terminal device 100. The buffer may output an image content to the image processor 220 or the display 230 using timestamp information included in an image stream.

The input unit 260 receives various user commands to control the external apparatus 200. In this case, the input unit 260 can be realized as a remote controller, but this is only an example. The input unit 260 may be realized as various input devices such as a pointing device, a motion input device, a voice input device, a mouse, a keyboard, etc.

The controller 270 may control overall operations of the external apparatus 200. Specifically, the controller 270 may control the communicator 240 to transmit a first image content to the user terminal device 100.

In addition, if data is received from the user terminal device 100 through the communicator 240 while a first image content is displayed, the controller 270 may control the reproduction of a first image content. In this case, if command data for changing a volume is received from the user terminal device 100, the controller 270 may change the volume. If command data for changing a channel is received from the user terminal device 100, the controller 270 may change the channel.

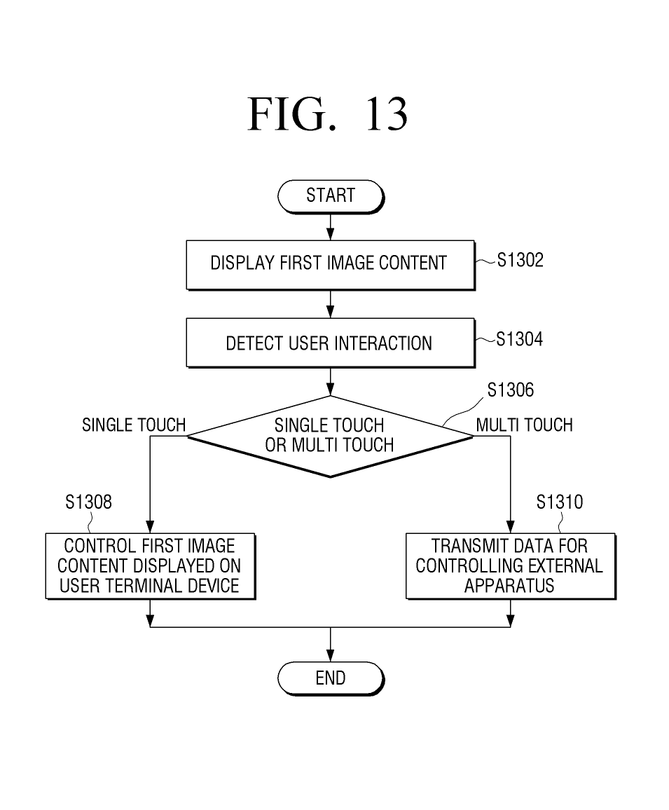

FIG. 13 is a flowchart provided to explain a controlling method of the user terminal device 100 according to an exemplary embodiment.

The user terminal device 100 displays a first image content (S1302). The first image content may be an image content received from the external apparatus 200, but this is only an example. The first image content may be another image content.

The user terminal device 100 determines a user interaction (S1304). The user interaction may be a touch gesture detected through the detector 130. The touch gesture may include single-touch, single-touch swipe, single-touch drag, single-touch scroll, multi-touch, multi-touch swipe, multi-touch drag and multi-touch scroll.

The user terminal device 100 determines whether a user interaction detected on the user terminal device 100 is a single-touch gesture or a multi-touch gesture (S1305). If a touch gesture detected on the user terminal device 100 is a single-touch gesture, the user terminal device 100 controls a first image content displayed on the user terminal device 100 (S1308), and if a touch gesture detected on the user terminal device 100 is a multi-touch gesture, the user terminal device 100 transmits data for controlling the external apparatus 200 (S1310).

As described above, according to an exemplary embodiment, a user may check an image content displayed on the first external apparatus 200 more easily through the user terminal device 100.

In the above-described exemplary embodiments, a display apparatus is taken as an example of the first external apparatus 200, but this is only an example. Various household electronic apparatuses such as an audio apparatus and a lighting apparatus may be controlled according to a user setting.

The method for controlling an external apparatus according to the above-described various exemplary embodiments may be realized as a program or software and provided in the external apparatus. Specifically, a non-transitory computer readable medium storing a program including a method for controlling an external apparatus may be provided.

The non-transitory recordable medium may refer to a medium which may store data semi-permanently rather than storing data for a short time such as a register, a cache, and a memory and may be readable by an apparatus. Specifically, the non-transitory readable medium may be CD, DVD, hard disk, Blu-ray disk, USB, memory card, ROM, etc.

The foregoing embodiments and advantages are merely exemplary and are not to be construed as limiting the present invention. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A method of controlling a user terminal device including a display, the method comprising:
displaying a first image content on the display;
detecting a touch gesture with respect to the user terminal;
in response to the touch gesture being a single-touch gesture, controlling the user terminal device; and
in response to the touch gesture being a multi-touch gesture, transmitting data for controlling a first external apparatus to the first external apparatus.

2. The method as claimed in claim 1, wherein the transmitting comprises, in response to the multi-touch gesture being a drag gesture using at least two fingers in an upward or downward direction, transmitting data for controlling a volume level of the first external apparatus.

3. The method as claimed in claim 1, wherein the transmitting comprises, in response to the multi-touch gesture being a swipe gesture using at least two fingers in a left or right direction, transmitting data for changing a channel of the first external apparatus.

4. The method as claimed in claim 1, wherein the transmitting comprises, in response to the multi-touch gesture being a swipe gesture using at least three fingers, transmitting data for turning off the first external apparatus.

5. The method as claimed in claim 1, wherein the transmitting comprises, in response to the multi-touch gesture being a rotation gesture using at least two fingers, transmitting data for removing a graphic object displayed on the first external apparatus.

6. The method as claimed in claim 1, wherein the first image content is received by the user terminal device from the first external apparatus, and the displaying of the first image content is synchronized with display of the first image content on the first external apparatus.

7. The method as claimed in claim 1, wherein the first image content is transmitted from a server, and the displaying of the first image content is synchronized with display of the first image content on the first external apparatus.

8. The method as claimed in claim 1, wherein the transmitting comprises transmitting data so that a function performed on the user terminal device according to the single-touch gesture is performed on the first external apparatus according to the multi-touch gesture in a same manner.

9. The method as claimed in claim 1, wherein the transmitting comprises transmitting data for changing an amount of change of a volume level or a channel of the first external apparatus based on a number of touch points detected in the multi-touch gesture.

10. The method as claimed in claim 1, wherein the transmitting comprises detecting a number of touch points in the multi-touch gesture, and transmitting data for controlling a first external apparatus or a second external apparatus based on the number of the detected number of touch points.

11. A user terminal device which operates in association with a first external apparatus, the device comprising:
a display configured to display a first image content;
a communicator configured to perform communication with the first external apparatus;
a detector configured to detect a touch gesture with respect to the user terminal device; and
a controller configured to control the user terminal device in response to the touch gesture detected by the detector being a single-touch, and control the communicator to transmit data for controlling the first external apparatus in response to the touch gesture detected by the detector being a multi-touch gesture.

12. A method of controlling a user terminal device and at least one external apparatus, the method comprising:
detecting a touch gesture on the user terminal device;
determining whether the detected touch gesture is a single-touch gesture or a multi-touch gesture;
controlling one of the user terminal device and the first external apparatus in response to the detected touch gesture being determined to be a single-touch gesture; and
controlling the other one of the user terminal device and the first external apparatus in response to the detected touch gesture being determined to be a multi-touch gesture,
wherein data for controlling the first external apparatus is transmitted by the user terminal device to the first external apparatus.

13. A user terminal device which operates in association with a first external apparatus, the device comprising:
a detector configured to detect a touch gesture on the user terminal device; and
a controller configured to determine whether the detected touch gesture is a single-touch gesture or a multi-touch gesture, control one of the user terminal device and the first external apparatus in response to the detected touch gesture being determined to be a single-touch gesture, and control the other of the user terminal device and the first external apparatus in response to the detected touch gesture being determined to be a multi-touch gesture,
wherein data for controlling the first external apparatus is transmitted by the user terminal device to the first external apparatus.

14. The user terminal device as claimed in claim 13, wherein the user terminal device is controlled in response to the controller determining that the detected touch gesture is a single-touch gesture and the first external apparatus is controlled in response to the controller determining that the detected touch gesture being is a multi-touch gesture.

15. The user terminal device as claimed in claim 13, wherein the first external apparatus is controlled in response to the controller determining that the detected touch gesture is a single-touch gesture and the user terminal device is controlled in response to the controller determining that the detected touch gesture being is a multi-touch gesture.

16. The user terminal device as claimed in claim 13, further comprising a display configured to a display an image content,
wherein the user terminal device receives an image content that is reproduced on the display of the user terminal device, wherein the reproduction of the image content on the display of the user terminal device is synchronized with the reproduction of the image content on the first external apparatus.

17. The user terminal device as claimed in claim 14, wherein the controller, in response to the multi-touch gesture being a drag gesture using at least two fingers in an upward or downward direction, controls a communicator to transmit data for controlling a volume level of the first external apparatus.

18. The user terminal device as claimed in claim 14, wherein the controller, in response to the multi-touch gesture being a swipe gesture using at least two fingers in a left or right direction, controls a communicator to transmit data for changing a channel of the first external apparatus.

19. The user terminal device as claimed in claim 14, wherein the controller, in response to the multi-touch gesture being a swipe gesture using at least three fingers, controls a communicator to transmit data for turning off the first external apparatus.

20. The user terminal device as claimed in claim 14, wherein the controller, in response to the multi-touch gesture being a rotation gesture using at least two fingers, controls a communicator to transmit data for removing a graphic object displayed on the first external apparatus.
